(19) United States
(12) Patent Application Publication
(10) Pub. No.: US 2004/0125237 A1
(43) Pub. Date: Jul. 1, 2004

(54) Fast slope calculation method for shot detection in a video sequence

(75) Inventors: Chunxi Chen, Shanghai (CN); Zhenrong Yang, Shanghai (CN)

Correspondence Address: Pillsbury Winthrop LLP, Intellectual Property Group, Suite 2800, 725 South Figueroa Street, Los Angeles, CA, 90017-5406, US

(73) Assignee: Intel Corporation, Santa Clara, CA

(21) Appl. No.: 10/335,521

(22) Filed: Dec. 31, 2002

(51) Int. Cl. H04N 7/12

(52) U.S. Cl. 348/700; 375/240.01

(57) ABSTRACT

A system includes a frame length determination device to determine a first length of a current frame, a second length of a previous frame, and a third length of a subsequent frame, in a sequence of frames. A slope determination device assigns a value to the current frame, the value being based on a relationship between the first length, the second length, and the third length. A shot detection device locates a shot in the sequence of frames, based on a comparison of the value with test slope values of test frames in the sequence of frames.

### BACKGROUND

1. Technical Field

This invention relates to the field of shot detection in video processing.

2. Description of the Related Arts

Digital video is formed of a sequence of video frames. The digital video is often sampled at 30 frames/second. The digital video can be compressed after it is captured and then stored in a medium, or it can be captured, compressed, and then sent through a network. The digital video is compressed based on “shots” in the digital video. A shot represents a continuous sequence of actions. Each shot is composed of a group of frames in the video sequence having continuity in some sense. For example, if a series of frames includes several different scenes, each scene would be represented by a different shot.

There are current systems for detecting shots in a video sequence. These systems require encoded frames to be decoded, fully or at least partially, into their raw data and then the raw data is analyzed to locate the shots. However, decoding the video data into its raw data and then performing the analysis utilizes much processing power, is slow, and consumes much of the available memory space. Shot detection systems are therefore deficient because they are too slow, and use much processing power and available memory space.

### BRIEF DESCRIPTION OF THE DRAWINGS

FIG. 1 illustrates a system diagram of a shot detection system according to an embodiment of the invention;

FIG. 2 illustrates a data stream which may be used according to an embodiment of the invention;

FIGS. 3A-3I illustrate a sequence of frames which may be used according to an embodiment of the invention;

FIG. 4A illustrates a plot of frame lengths according to an embodiment of the invention;

FIG. 4B illustrates a graph showing the SC values for frames according to an embodiment of the invention;

FIG. 5 illustrates a method of calculating frame lengths of frames in a data stream according to an embodiment of the invention;

FIG. 6A illustrates a first portion of a method to calculate slope values for frames according to an embodiment of the invention;

FIG. 6B illustrates a second portion of a method to calculate slope values for frames according to an embodiment of the invention;

FIG. 7 illustrates a shot detection method according to an embodiment of the invention;

FIG. 8 illustrates a video archival system according to an embodiment of the invention; and

FIG. 9 illustrates a video system according to an embodiment of the invention.

### DETAILED DESCRIPTION

An embodiment of the invention may be utilized to detect a shots in a video sequence. The video sequence may be comprised of encoded (i.e., compressed) frames of video data. For example, the video sequence may be a compressed stream of frames, where the first frame is an intra-coded frame (i.e., an I-frame), and subsequent frames are predictive-coded frames (i.e., P-frames). To display the video, the encoded video data may be decoded and then shown to a user by a video rendering device. The frames may be encoded via a compression scheme such as Motion Picture Experts Group Layer 4 (MPEG4), ISO/IEC 14496-2, Dec. 12, 2001, second edition, or H.263, ITU Draft H.263, Jan. 17, 1998. Each of the encoded frames may be analyzed to determine their lengths (i.e., the number of bytes). Each encoded frame may have a length which is dependent upon the characteristics (e.g., color of the pixel relative to the colors of adjacent pixels, as well as the color of the same pixel in a previous frame, etc.) of pixels within the frame. In general, the length is dependent upon how closely related the characteristics of the pixels are. For example, if a frame consists of a uniform background (e.g., all yellow pixels), then the frame can be encoded and represented by a small number of bytes. However, if the frame contains much detail (e.g., many different objects having different colors, or much movement of pixels (e.g., much “pixel flow” between successive frames), many more bytes may be required to represent the encoded frame.

Accordingly, if the first several frames in a video sequence all have the same relatively uniform background color, or relatively little detail, then each of the frames may be compressed, and the compressed frames may each be represented by a relatively small number of bytes. However, if the next set of frames each contain many objects having differing colors, or much detail, then each of the frames in the next set of frames may be represented by a relatively large number of bytes. If the lengths of each of the frames in the video sequence is determined and plotted on a graph, the slope between successive points may be determined and analyzed. The slope of each point may be determined based on a comparison of the length of each encoded frame with the lengths of the previous and subsequent frames. When the one compressed frame is represented by many more bytes than the previous and/or next frame, the system may determine that the slope between the bytes for consecutive frames is large, and based upon the slope, may determine that the consecutive frames belong to different shots. Once the shots have been located, the video sequence may be manipulated accordingly.

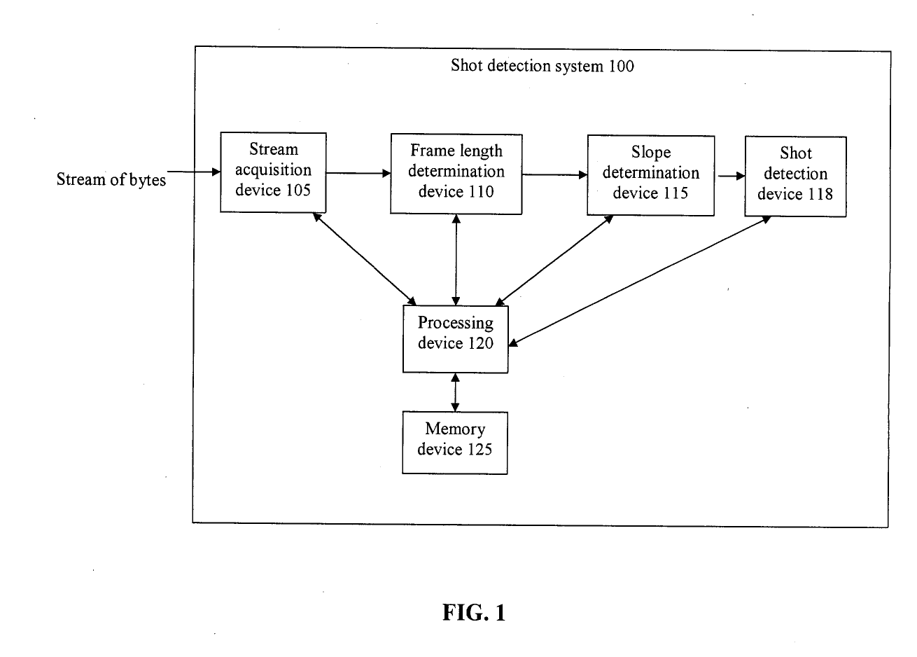

FIG. 1 illustrates a system diagram of a shot detection system 100 according to an embodiment of the invention. As shown, a stream of bytes is received by a stream acquisition device 105 of the shot detection device. The stream of shots may be received from a video camera, for example, or from a prerecorded video file. Once the stream has begun to be received, it is analyzed by a frame length determination device 110. The frame length determination device 110 may have a function of determining the length of each of the compressed frames within the video sequence.

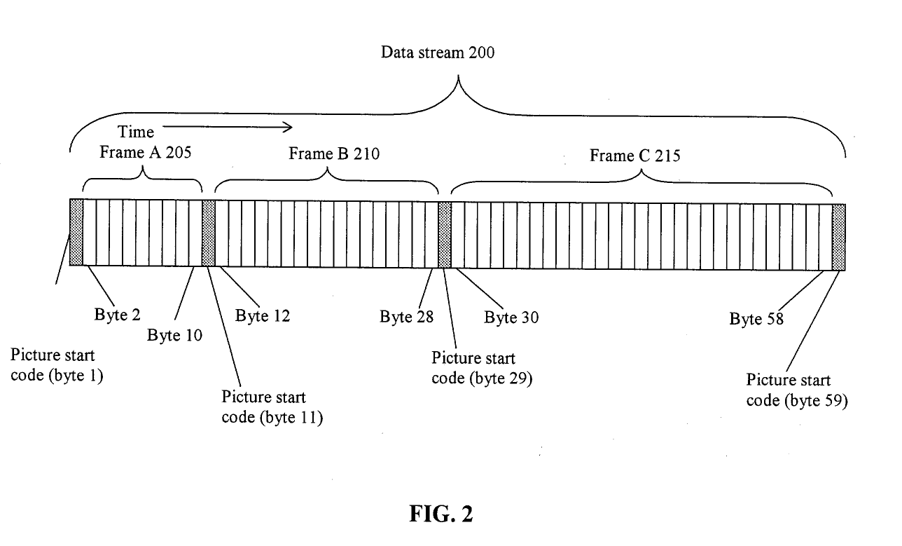

FIG. 2 illustrates a data stream 200 which may be used according to an embodiment of the invention. The data stream 200 may be comprised of a plurality of bytes representing the video data. Each frame may be represented by a plurality of bytes, separated from the previous and the next frames by picture start code bytes. As shown in FIG. 2, byte 1 is a picture start code byte. The picture start code byte indicates that the next byte is the first byte of the frame. Therefore, byte 2 is the first byte in frame A 205, and the rest of the bytes up through byte 10 are also part of frame A 205. Byte 11 represents another picture start code. Byte 12 is the first byte of frame B 210, and byte 28 is the last byte of the frame B. Bytes 29 and 59 are additional picture start code bytes in the data stream 200. Frame A 205 therefore has a length of 9 bytes, frame B 210 has a length of 17 bytes, and frame C 215 has a length of 29 bytes. The picture start codes in FIG. 2 are shown as each having a length of a single for illustrative purposes. In reality, the picture start code may have a length greater than a single byte. For example, the picture start code in an MPEG 4 stream may consume 4 bytes, and the picture start code in an H.263 stream may consume 22 bytes.

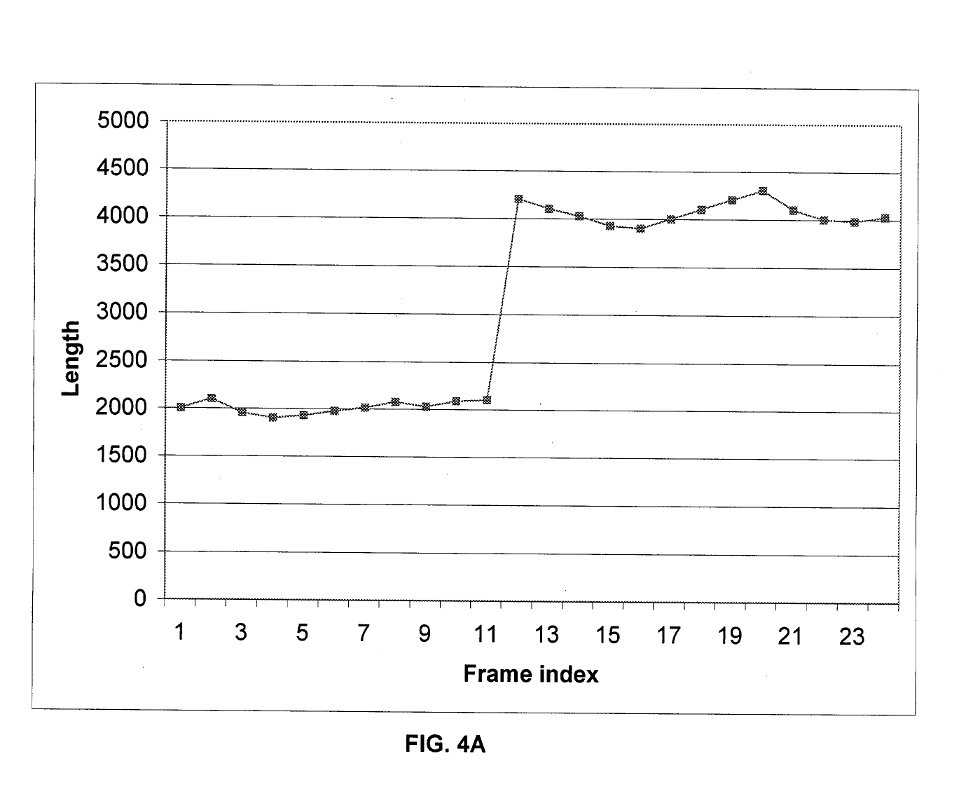

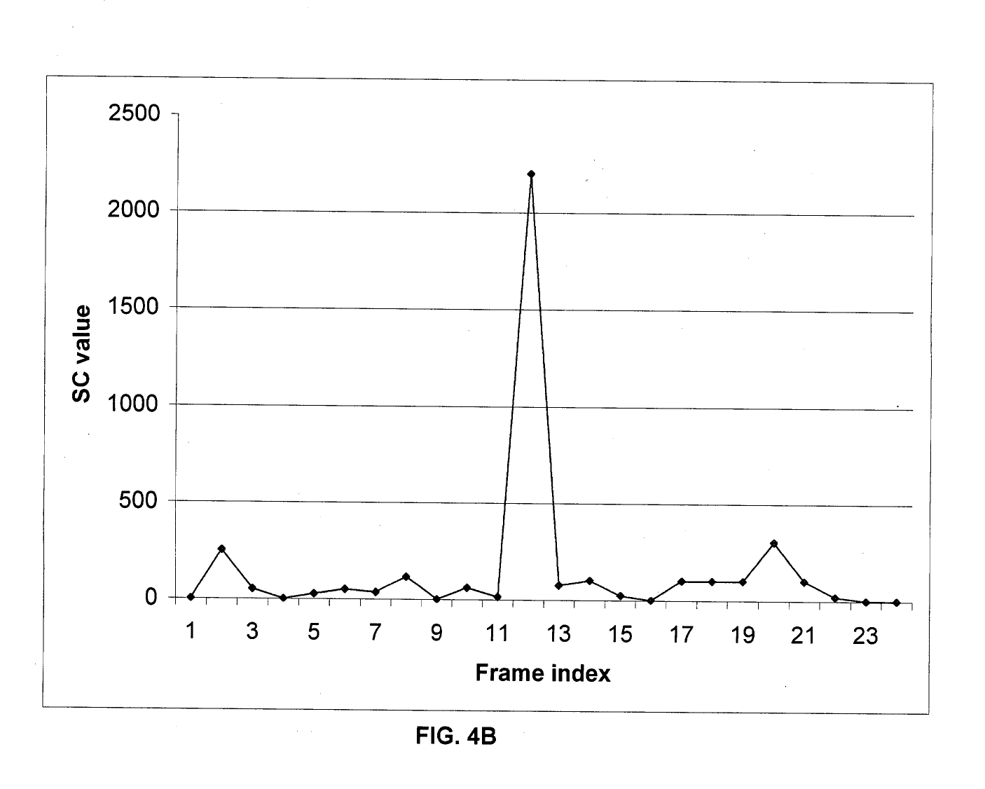

Referring FIG. 1, the frame length determination device 110 may determine the length of a frame within the data stream 200 by first locating successive picture start code bytes. Next, the frame length determination device 110 may subtract the byte number of the first byte of the frame from the byte number of the next picture start code byte. For example, if byte number 12 is the first byte of a frame, and byte number 29 is the next picture start code byte, the frame length determination device 110 may determine the length of the frame to be 17 bytes (i.e., 29−12=17). Once the frame length has been determined, the frame length information may be sent to a slope determination device 115. The slope determination device may calculate a slope between consecutive plotted points on a graph of frame number versus bytes used to represent a frame (as discussed below with respect to FIGS. 4A-7). The slope determination device 115 may output the calculated slope values to a shot detection device 118, which may detect the shots based on the calculated slope values.

Each of the stream acquisition device 105, the frame length determination device 110, the slope determination device 115, and the shot detection device 118 may be in communication with a processing device 120. The processing device 120 may be in communication with a memory device 125, which may hold program code to be executed by the processing device 120. Alternatively, each of the stream acquisition device 105, the frame length determination device 110, the slope determination device 115, and the shot detection device 118 may contain their own processing devices and/or memory devices to store program code to be executed by the processing devices.

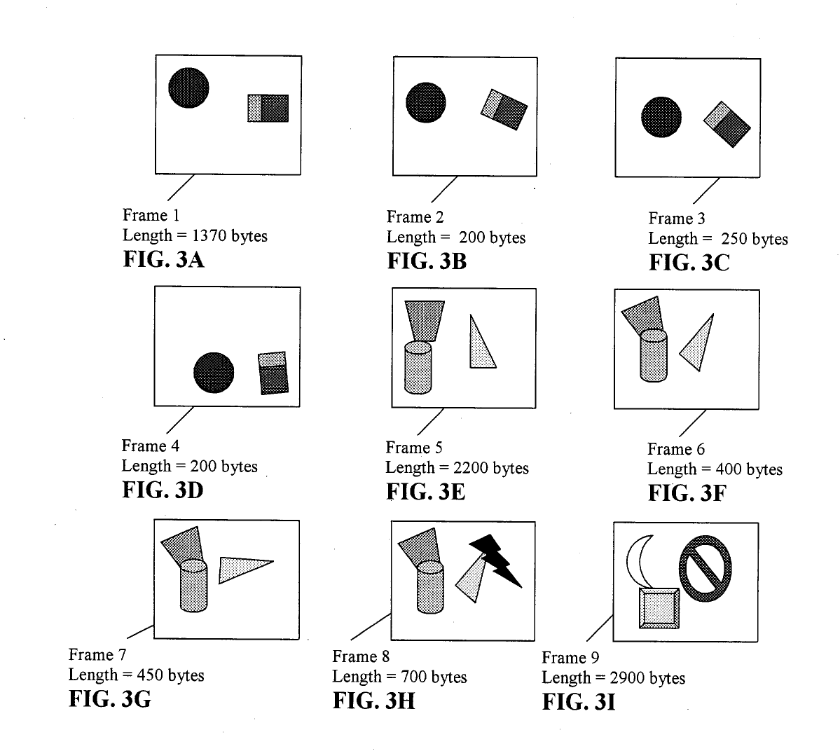

FIGS. 3A-3I illustrate a sequence of frames according to an embodiment of the invention. As shown, each of the frames contains objects, some of which move from frame to frame. FIG. 3A illustrates frame 1. As shown, frame 1 shows a circular object in the upper left-hand corner and a short box that is coupled to an end of a long box, the boxes being located on the middle half of the scene, toward the right-hand side. Frame 1 may be compressed as an intra-coded frame (i.e., an I-frame) having a byte length of 1370 bytes, for example. The number of bytes to which a frame can be compressed may be dependent upon the amount of detail in the frame (e.g., the size of the frame, the number of different objects in the frame, the amount of different colors in the frame, etc.).

FIG. 3B illustrates frame 2. As shown, frame 2 contains the same objects as in frame 1, but the circular object has moved down and to the right, and the boxes have rotated slightly clockwise. Frame 2 is compressed as a predictive-coded frame (i.e., a P-frame), which it only needs to record the differences between frame 2 and frame 1. Accordingly, it only consumes 200 bytes.

FIG. 3C illustrates frame 3. As shown, frame 3 contains the same objects as those of frames 1 and 2, but moved slightly. The circular object has moved down further and to the right of its position in frame 2. The boxes have been rotated further in a clockwise direction. To be compressed as a P-frame, it may consume 250 bytes.

FIG. 3D illustrates frame 4. As shown, frame 4 contains the same objects as those of frames 1, 2, and 3, but moved slightly. The circular object has again moved further down and to the right of its position in frame 3. Also, the boxes have been rotated even further in a clockwise direction. Frame 4 may be compressed to a size of 200 bytes as a P-frame.

FIG. 3E illustrates frame 5. As shown, frame 5 contains objects different from those in frames 1-4. Specifically, frame 5 contains a trapezoid, a cylinder, and a triangle. Frame 5 may be compressed as a P-frame. However, because the difference between frame 5 and frame 4 is great, frame 5 consumes many more bytes. For example, frame 5 may be compressed to a size of 2200 bytes.

FIG. 3F illustrates frame 6. As shown, frame 6 contains the same objects as those of frame 5. The trapezoid has rotated slightly counterclockwise, and the triangle has rotated slightly clockwise. Because of the similarity between frames 5 and 6, frame 6 may be compressed as a P-frame consuming just 400 bytes.

FIG. 3G illustrates frame 7. As shown, frame 7 contains the same objects as those of frame 6. The trapezoid and the cylinder remain in the same relative locations as they were in frame 6. The triangle has rotated clockwise. Frame 7 may be compressed to a size of 450 bytes as a P-frame.

FIG. 3H illustrates frame 8. As shown, frame 8 contains the trapezoid, cylinder, and triangle as frame 7. However, the triangle has rotated slightly counterclockwise. Frame 8 also includes a lightning bolt. Although most of frame 8 is similar as frame 7, but it has a totally new object, so frame 8 will consume more bytes than frame 7. Frame 8 may be compressed to a size of 700 bytes as a P-frame

FIG. 3I illustrates frame 9. As shown, frame 9 contains objects different than those of the previous frames (i.e., frames 1-8). Frame 9 contains a crescent, a box, and a circular object with a line through its center. Frame 9 may be compressed as a P-frame consuming 2900 bytes.

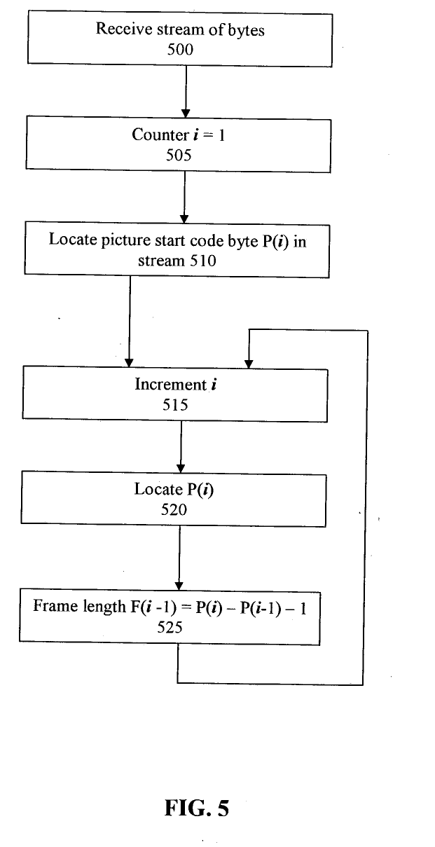

Frames 1-9 as shown for illustrative purposes. In reality, each of frames 1-9 may be compressed to a different number of bytes. Frames 1-4 may represent a first shot, frames 5-8 may represent a second shot and frame 9 may represent the start of a third shot. The shots may be determined by analyzing the lengths of the frames. Frames within the same shot except the first frame may each be compressed to a similar number of bytes. For example, the first shot (i.e., that formed by frames 1-4) is formed of frames having sizes between 200 and 250 bytes except the frame 1. The second shot (i.e., that formed by frames 5-8) is formed of frames having sizes between 400 and 700 bytes except the frame 5. The start of the third shot (i.e., frame 9) has a size of 2900 bytes. Accordingly, the frames in each of the shots each except the first frame are within a certain range of each other while the first frame of the shot has an abrupt value. Accordingly, to locate a shot in a stream of frames, the shot detection system 100 may search for such abrupt value by the method described below with respect to Table A and FIGS. 5-7. Although the shots for the frames shown in FIGS. 3A-3I are shown as being represented by only a few frames, many more frames may be contained within a shot.

As the data stream 200 is received, the lengths of each frame in the data stream 200 may be determined. The frame lengths may then be analyzed to determine a “slope calculation” (“SC”) between two consecutive frames. The SC is based on a comparison of the frame lengths of consecutive frames. Where the data stream 200 is comprised of frames, the lengths of which form the sequence “FL” (where “FL” stands for “frame length”), and FL={C₁, C₂, C₃, . . . , C_{N}}. SC may be calculated based on the following parameters (wherein “ABS” means “absolute value”):

1. Where Cᵢ>Cᵢ₋₁ and Cᵢ>Cᵢ₊ᵢ, SC=ABS(Cᵢ−Cᵢ₋₁)+ABS(Cᵢ−Cᵢ₊₁)

2. Where Cᵢ>Cᵢ₋₁ and Cᵢ≦Cᵢ₊₁, SC=ABS(Cᵢ−Cᵢ₋₁)

3. Where Cᵢ>Cᵢ₊₁ and Cᵢ≦Cᵢ₋₁, SC=ABS(Cᵢ−Cᵢ₊₁); and

4. In every other scenario, SC=0

The above-listed parameters have been found to yield good results. Once the SC has been determined for a frame, the SC for the frames may then be analyzed to determine whether the first frame of a shot is present in the data stream. When the following additional conditions are met, the shot detection system 100 may determine the existence of a shot:

1. (k−T<i<k+T, i≠k); and

2. (SCₖ>SCᵢ* X); and

3. (SCₖ>AVG)

K represents the shot start position (i.e., the first frame in a shot), and T is a pre-defined value which represents a comparison frame range—e.g., from frame k−T to frame k+T (in other words, the SC of each frame from k−T to frame k+T are compared with SCₖ of frame k). X is a multiplication factor by which to multiple SCᵢ when comparing with SCₖ. The SC of the first frame of a shot (i.e., frame k) is typically much larger (e.g., more than “X” times as large) than the value of the SC for each of the other frames in the shot. Accordingly, this property may be utilized in detecting the shot. AVG is a threshold which may be determined dynamically based the SC values of the previous frames in the data stream 200 (e.g., (the sum of the SC values of all previous frames) divided by (the number of previous frames)). To be determined to be the first frame of a shot, an embodiment may require that SCₖ be larger than AVG.

Table A below illustrates frames (these are different than the frames shown in FIGS. 3A-3I), their associates frame lengths, as well as their associated SC condition (based on the conditions listed above) and calculated SC value.

TABLE A

| Frame | | | |
|---|---|---|---|
| index | Length | SC condition | SC value |
| 1 | 2000 | — | 0 |
| 2 | 2100 | Cᵢ > Cᵢ₋₁; Cᵢ> Cᵢ₊₁ | 250 |
| 3 | 1950 | Cᵢ < Cᵢ₋₁; Cᵢ> Cᵢ₊₁ | 50 |
| 4 | 1900 | Cᵢ < Cᵢ₋₁; Cᵢ< Cᵢ₊₁ | 0 |
| 5 | 1925 | Cᵢ > Cᵢ₋₁; Cᵢ< Cᵢ₊₁ | 25 |
| 6 | 1975 | Cᵢ > Cᵢ₋₁; Cᵢ< Cᵢ₊₁ | 50 |
| 7 | 2010 | Cᵢ > Cᵢ₋₁; Cᵢ< Cᵢ₊₁ | 35 |
| 8 | 2075 | Cᵢ > Cᵢ₋₁; Cᵢ> Cᵢ₊₁ | 115 |
| 9 | 2025 | Cᵢ < Cᵢ₋₁; Cᵢ< Cᵢ₊₁ | 0 |
| 10 | 2085 | Cᵢ > Cᵢ₋₁; Cᵢ< Cᵢ₊₁ | 60 |
| 11 | 2100 | Cᵢ > Cᵢ₋₁; Cᵢ< Cᵢ₊₁ | 15 |
| 12 | 4200 | Cᵢ > Cᵢ₋₁; Cᵢ> Cᵢ₊₁ | 2200 |
| 13 | 4100 | Cᵢ < Cᵢ₋₁; Cᵢ> Cᵢ₊₁ | 75 |
| 14 | 4025 | Cᵢ < Cᵢ₋₁; Cᵢ> Cᵢ₊₁ | 101 |
| 15 | 3924 | Cᵢ < Cᵢ₋₁; Cᵢ> Cᵢ₊₁ | 24 |
| 16 | 3900 | Cᵢ < Cᵢ₋₁; Cᵢ< Cᵢ₊₁ | 0 |
| 17 | 4000 | Cᵢ > Cᵢ₋₁; Cᵢ< Cᵢ₊₁ | 100 |
| 18 | 4100 | Cᵢ > Cᵢ₋₁; Cᵢ< Cᵢ₊₁ | 100 |
| 19 | 4200 | Cᵢ > Cᵢ₋₁; Cᵢ< Cᵢ₊₁ | 100 |
| 20 | 4300 | Cᵢ > Cᵢ₋₁; Cᵢ> Cᵢ₊₁ | 300 |
| 21 | 4100 | Cᵢ < Cᵢ₋₁; Cᵢ> Cᵢ₊₁ | 100 |
| 22 | 4000 | Cᵢ < Cᵢ₋₁; Cᵢ> Cᵢ₊₁ | 20 |
| 23 | 3980 | Cᵢ < Cᵢ₋₁; Cᵢ< Cᵢ₊₁ | 0 |
| 24 | 4025 | — | 0 |

FIG. 4A illustrates a plot of frame lengths for each of the frames listed above. As shown, the first 11 frames all have lengths close to 2000 bytes. Specifically, the first 11 frames are in a range between 1900 and 2100 bytes in length. Frames 12 through 24, on the other hand, are all close to 4000 bytes in length. Specifically, frames 12 through 24 are in a range between 3900 and 4300 bytes in length.

Each of frames 12-24 may have more bytes than each of frames 1-11 because they correspond to frames having a greater level of detail and having more motion. Accordingly, frames 1-11 may comprise a first shot, and frames 12-24 may comprise a second shot.

After the frame length of each frame has been determined, the SC for each frame may then be determined. The frame length of a frame Cᵢ may be compared with the frame length of the previous frame (frame Cᵢ₋₁) as well as with the frame length of the next frame (frame Cᵢ₊₁). Based upon the relationship between these lengths, the condition for determining the SC value may be determined. For frame C₁, SC₁ is set to 0 because there is no frame 0 to which to compare the length of frame 1. So SC₁ is by definition set to 0. Similarly, for the last frame, C₂₄, SC₂₄ is set to 0 because there is no subsequent frame 25 to compare with frame C₂₄. Next, SC₂ for frame 2 is determined. Because C₁ (i.e., Cᵢ₋₁) is 2000, C₂ (i.e., Cᵢ) is 2100, and C₃ (i.e., Cᵢ₊₁) is 1950, the slope determination device 115 may determine that Cᵢ>Cᵢ₋₁ and Cᵢ>Cᵢ₊₁. Accordingly, based on the SC requirements, by definition, SC₂ is equal to ABS(Cᵢ−Cᵢ₋₁)+ABS(Cᵢ−Cᵢ₊₁). Therefore, SC₂=ABS(2100−2000)+ABS(2100−1950), which is 250.

Next, the system may calculate SC₃. For frame 3, C3=1950, C2=2100, and C4=1900. Accordingly, because condition Cᵢ<Cᵢ₋₁, and Cᵢ>Cᵢ₊₁ is met, SC₃ is, by definition, ABS(Cᵢ−Cᵢ₊₁). SC₃ is therefore equal to ABS(1950−1900), which is 50. The SC values for frames 4-23 are calculated in a similar manner, and are listed in Table A above.

FIG. 4B illustrates a graph showing the SC values for each of frames 2-23 of the frame index. As illustrated, most of the frames have relatively small SC values. However, frame 12 has a large value for SC. As shown in FIG. 4B as well as in Table A above, SC₁₂ has a value of 2200. The next highest value of SC (i.e., SC₂₀) is 300. Accordingly, SC₁₂ is greater than 7 times as large as the next highest SC. The shot detection system 100 may determine the existence of a shot beginning at frame 12 due to the large spike in SC shown in FIG. 4B. Provided SC₁₂ is greater than X times as large as the next highest SC value, frame 12 may be determined to be the first frame of a shot, e.g., if X is set to 3, this condition is met. Therefore, a shot is would only be detected where the SC of a frame is at least three times as large as the SC of any other frame being analyzed.

In order for frame 12 to be determined to be the first frame of a shot, SC₁₂ may also be compared with a minimum shot threshold. The threshold may be preset to a value such as 1500, or may be determined dynamically—e.g., based on calculated values of SC for previous frames. Provided the threshold is less than 2200, the SC₁₂ may be determined to be the first frame of a shot.

FIG. 5 illustrates a method of calculating frame lengths of frames in a data stream 200 according to an embodiment of the invention. First, a stream of bytes is received 500. Next, counter i is initialized 505 to a value of “1.” The initial picture start code byte P(i) is then located 510 in the data stream 200. Next, counter i is incremented 515. The system then searches for and locates 520 the next picture start code byte P(i). The frame length F(i−1) is calculated 525 to be the difference between P(i) and P(i−1) minus 1. In other words, F(i−1)=P(i) −P(i−1)−1. So if the first picture start code byte (i.e., P(i−1)) is byte #2, and the second picture start code byte (i.e., P(i)) is byte #10, F(1)=10 (i.e., P(2))−2 (i.e., P(1))−1, which is 7.

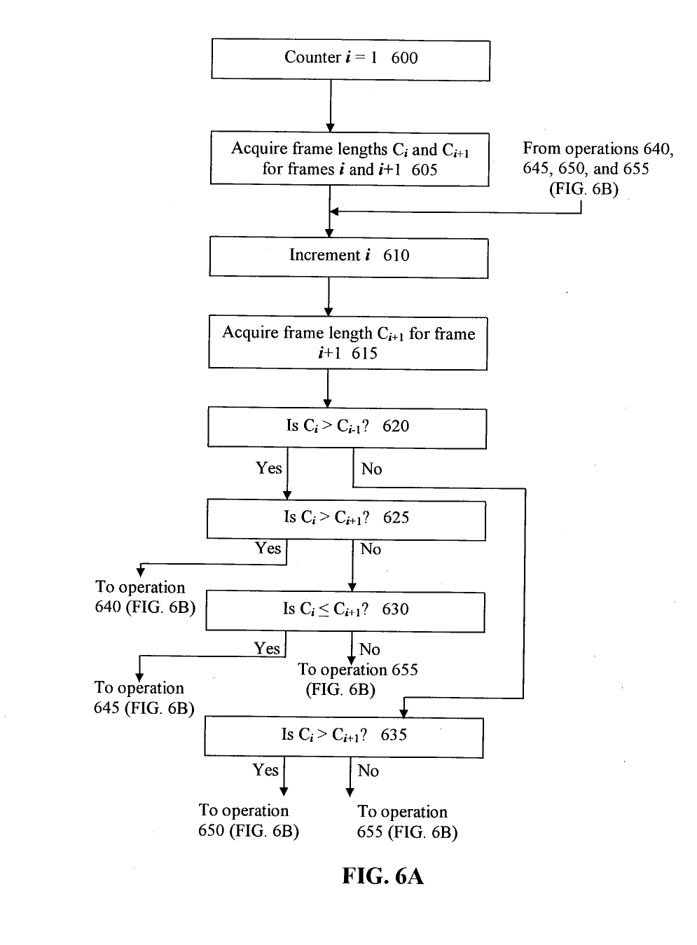

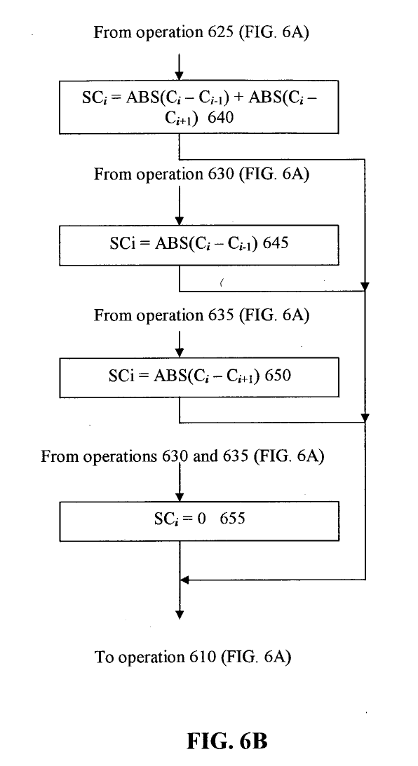

FIG. 6A illustrates a first portion of a method to calculate slope values for frames according to an embodiment of the invention. First, a counter i is set 600 to “1.” Next, frame lengths Cᵢ and Cᵢ₊₁ are acquired 605 for frames i and i+1. Counter I is then incremented 610. the frame length Cᵢ₊₁ is acquired 615 for frame i+1. The system then determines 620 whether Cᵢ>Cᵢ₋₁. If “no,” processing proceeds to operation 635. If “yes,” processing continues to operation 625, where the system determines whether Cᵢ>Cᵢ₊₁. If “no,” processing proceeds to operation 630. If “yes,” processing proceeds to operation 640 shown in FIG. 6B.

At operation 630, the system determines whether Cᵢ≦Cᵢ₊₁. If “no,” processing proceeds to operation 635. If “yes,” processing proceeds to operation 645 shown in FIG. 6B. At operation 635, the system determines whether Cᵢ>Cᵢ₊₁. If “no,” processing proceeds to operation 655 shown in FIG. 6B. If “yes,” processing proceeds to operation 650 shown in FIG. 6B.

FIG. 6B illustrates a second portion of a method to calculate slope values for frames according to an embodiment of the invention. At operation 640, SCᵢ is calculated to be the absolute value of (Cᵢ−Cᵢ₋₁) plus the absolute value of (Cᵢ−Cᵢ₊₁). Processing then proceeds to operation 610 shown in FIG. 6A. At operation 645, SCᵢ is calculated to be the absolute value of (Cᵢ−Cᵢ₋₁). Processing then proceeds to operation 610 shown in FIG. 6A. At operation 650, SCᵢ is calculated to be the absolute value of (Cᵢ−Cᵢ₊₁). Processing then proceeds to operation 610 shown in FIG. 6A. Finally, at operation 655, SCᵢ is set to “0.” Processing then proceeds to operation 610 shown in FIG. 6A.

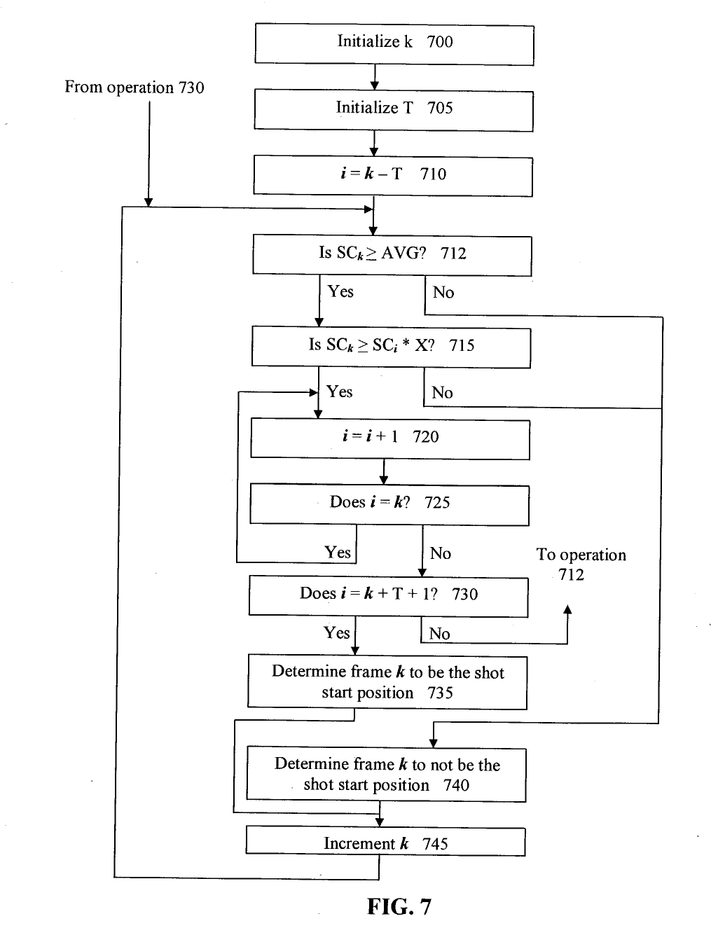

FIG. 7 illustrates a shot detection method according to an embodiment of the invention. After SC values have been calculated, the system may analyze the SC values to locate the first frame in a shot. The system may compare a frame length of a candidate frame with frame lengths of the T (T may be a predetermined number) previous frames and the T subsequent frames. The first frame of the shot may have an SC value that is much larger than that of the adjacent frames.

First, counter k is initialized 700. Counter k may be utilized to represent a frame for analyzing to determine whether it is the first shot of a frame. Parameter T is then initialized 705. Next, counter i is set 710 to the value k−T. The system then determines 712 whether SCₖ≧AVG, where AVG represents a threshold value. AVG may be determined dynamically based the SC values of the previous frames in the data stream 200 (e.g., (the sum of the SC values of all previous frames) divided by (the number of previous frames)). If “yes,” processing continues to operation 715. If “no,” processing proceeds to operation 740. Next, the system determines 715 whether SCₖ≧SCᵢ* X, SCₖ being the SC value for the candidate frame being tested to determine whether it is the first frame of a shot, SCᵢ being the SC value for the frame being compared with the candidate frame, and X being the multiplication factor discussed above with respect to Table A. If “yes,” processing proceeds to operation 720. In “no,” processing proceeds to operation 740. Next, at operation 720, counter i is incremented. The system then determines 725 whether counter i is equal to k. If “yes,” processing proceeds to operation 720. In “no,” processing proceeds to operation 730, where the system determines whether counter i is equal to k+T+1. If “yes,” processing proceeds to operation 735. If “yes,” then the SC of the entire range of frames from frame (k−T) to frame (k+T) has been successfully compared with SCₖ. If “no” at operation 735, processing proceeds to operation 712. At operation 735, the system determines frame k to be the first frame of a shot, and processing proceeds to operation 745. At operation 740, the system determines that frame k is not the starting frame of a shot and processing proceeds to operation 745. At operation 745, k is incremented, and then processing proceeds to operation 712.

For purposes of sorting and arranging the scenes in a video sequence, it may be necessary to locate the shots in the video sequence. For example, if multiple scenes are contained within a large video files, it is useful to be able to locate the different shots within the video file. Accordingly, a database may receive a stream of video data, and may then locate the shots in the stream, and archive the shots in the database, allowing for easy retrieval. Alternatively, the database may receive and store the stream, and then locate the shots, and store an index mapped up to the shots.

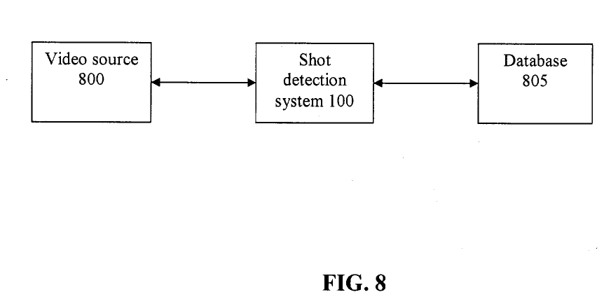

FIG. 8 illustrates a video archival system according to an embodiment of the invention. A video source 800 may supply a stream of video data to a shot detection system 100. The video source may be a video camera or a website on the Internet, for example. The shot detection system 100 may receive the video stream, detect the shots in the video stream, and then transmit the video stream and the information concerning the detected shots to database 805, where the shots in the video stream may be archived.

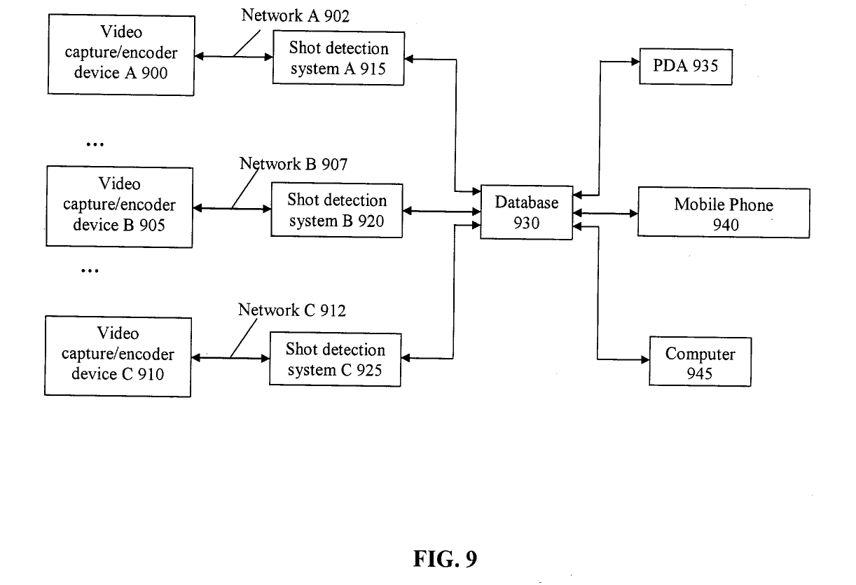

FIG. 9 illustrates a video system according to an embodiment of the invention. The video system may include three video capture/encoding devices: (a) video capture/encoder device A 900, (b) video capture/encoder device B 905, and (c) video capture/encoder device C 910. In other embodiments, more or fewer than 3 such video capture/encoder devices may be utilized. Each of the video capture/encoder devices (e.g., A 900, B 905, or C 910) may include a video camera and may have a function of capturing and encoding video data. Video capture/encoder device A 900 may be in communication with shot detection system A 915 via network A 902. Network A may be the Internet, for example. Video capture/encoder device A 900 may output a stream of encoded video data via network A 902, to shot detection system A 915, which may receive the stream and locate shots contained within the stream. Similarly, shot detection systems B 920 and C 925 may be in communication with video capture/encoder devices B 905 and C910, respectively, via networks B 907 and C 912, respectively.

Each of the shot detection systems (e.g., A 915, B 920, and C 925) may locate the shots quickly (in close to “real time”) and may output the stream and associated shot information to a database 930. The database 930 may archive the video data and/or transmit the video data to other devices for display, such as Personal Digital Assistant (PDA) 935, computer 950, or television 945 via the radio spectrum through use of antenna 940, for example. The video data may also be transmitted via cable.

While the description above refers to particular embodiments of the present invention, it will be understood that many modifications may be made without departing from the spirit thereof The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A system, comprising:
a frame length determination device to determine a first length of a current frame, a second length of a previous frame, and a third length of a subsequent frame, in a sequence of frames;
a slope determination device to assign a value to the current frame, the value being based on a relationship between the first length, the second length, and the third length; and
a shot detection device to locate a shot in the sequence of frames, based on a comparison of the value with test slope values of test frames in the sequence of frames.

2. The system of claim 1, further including a stream acquisition device to receive a stream of video data from a video source and supply the sequence of frames to the frame length determination device.

3. The system of claim 1, wherein the value is the sum of a first difference between the first length and the second length, and a second difference between the first length and the third length when the first length is greater than each of the second length and the third length.

4. The system of claim 1, wherein the value is a difference between the first length and the second length, when the first length is greater than the second length and the first length is not greater than the third length.

5. The system of claim 1, wherein the value is a difference between the first length and the third length, when the second length is not less than the first length and the first length is greater than the third length.

6. The system of claim 1, wherein the shot detection device locates the shot when the value is greater than or equal to the test slope values.

7. The system of claim 1, wherein the shot detection device locates the shot when the value is greater than or equal to a threshold slope value.

8. The system of claim 1, wherein the shot detection device transmits a location of the shot in the sequence of the frames to a database which archives the sequence of the frames.

9. A method, comprising:
determining a first length of a current frame, a second length of a previous frame, and a third length of a subsequent frame, in a sequence of frames;
assigning a value to the current frame, the value being based on a relationship between the first length, the second length, and the third length; and
locating a shot in the sequence of frames, based on a comparison of the value with test slope values of test frames in the sequence of frames.

10. The method of claim 9, further including receiving a stream video data and supplying the sequence of frames to the frame length determination device.

11. The method of claim 9, wherein the value is determined by summing a first difference between the first length and the second length, and a second difference between the first length and the third length when the first length is greater than each of the second length and the third length.

12. The method of claim 9, wherein the value is a difference between the first length and the second length, when the first length is greater than the second length and the first length is not greater than the third length.

13. The method of claim 9, wherein the value is a difference between the first length and the third length, when the second length is not less than the first length and the first length is greater than the third length.

14. The method of claim 9, further including locating the shot when the value is greater than of equal to the test slope values.

15. The method of claim 9, further including locating the shot when the value is greater than or equal to a threshold slope value.

16. The method of claim 9, further including transmitting a location of the shot in the sequence of the frames to a database which archives the sequence of the frames.

17. An article comprising:
a storage medium having stored thereon instructions that when executed by a machine result in the following:
determining a first length of a current frame, a second length of a previous frame, and a third length of a subsequent frame, in a sequence of frames;
assigning a value to the current frame, the value being based on a relationship between the first length, the second length, and the third length; and
locating a shot in the sequence of frames, based on a comparison of the value with test slope values of test frames in the sequence of frames.

18. The article of claim 17, wherein the instructions further result in receiving a stream of video data and supplying the sequence of frames to the frame length determination device.

19. The article of claim 17, wherein the value is determined by summing a first difference between the first length and the second length, and a second difference between the first length and the third length when the first length is greater than each of the second length and the third length.

20. The article of claim 17, wherein the value is a difference between the first length and the second length, when the first length is greater than the second length and the first length is not greater than the third length.

21. The article of claim 17, wherein the value is a difference between the first length and the third length, when the second length is not less than the first length and the first length is greater than the third length.

22. The article of claim 17, wherein the instructions further result in locating the shot when the value is greater than or equal to the test slope values.

23. The article of claim 17, wherein the instructions further result in locating the shot when the value is greater than or equal to a threshold slope value.

24. The article of claim 17, wherein the instructions further result in transmitting a location of the shot in the sequence of the frames to a database which archives the sequence of the frames.
